(19) United States
(12) Patent Application Publication
(10) Pub. No.: US 2026/0368389 A1
(43) Pub. Date: Nov. 19, 2026

(54) DEBUGGING DEVICE, DEBUGGING METHOD, AND PROGRAM

(71) Applicant: NEC Corporation, Tokyo (JP)

(72) Inventors: Dai KUBOTA, Tokyo (JP); Yuta IDEGUCHI, Tokyo (JP); Fumiyo TAKANO, Tokyo (JP); Ryutaro DOI, Tokyo (JP); Nobutatsu NAKAMURA, Tokyo (JP)

(73) Assignee: NEC Corporation, Tokyo (JP)

(21) Appl. No.: 19/139,975

(22) PCT Filed: Dec. 26, 2022
(86) PCT No.: PCT/JP2022/048010

§ 371 Date: Jun. 17, 2025

(51) Int. Cl. G06F 30/20; G06F 111/04

(52) U.S. Cl. CPC G06F 30/20; G06F 2111/04

(57) ABSTRACT

In order to solve the problem of automatically and efficiently carrying out the task of debugging constraint conditions imposed on an optimization problem, a debugging apparatus (1) includes: a dividing section (11) for dividing, in a case where there is no solution to an optimization problem, a plurality of constraint conditions into a plurality of groups; and a determining section (12) for decision making by determining a group exclusion of which causes the optimization problem to have a solution, by repeatedly carrying out a process of selecting at least one group to judge whether there is a solution to the optimization problem under a constraint condition included in a group other than the at least one group selected.

### TECHNICAL FIELD

The present invention relates to a debugging apparatus and a debugging method for debugging constraint conditions imposed on an optimization problem. The present invention also relates to a program for causing a computer to function as such a debugging apparatus.

### BACKGROUND ART

In various industries, plan formulation is carried out with use of a mathematical model that is an optimization problem. An optimization problem includes: an objective function which represents utility; and a constraint condition which defines the range in which to search for a solution. For example, Patent Literature 1 discloses a software inspection apparatus for inspecting software by receiving software to be inspected, a constraint condition on the value of an input to the software, and an inspection condition regarding the software and then carrying out satisfiability judgment with use of a constrained optimization solver.

### CITATION LIST

### Patent Literature

### [Patent Literature 1]

International Publication No. WO 2016/121074

### SUMMARY OF INVENTION

### Technical Problem

As the constraint condition imposed on an optimization problem, a mathematical expression inputted by a user is typically used. If a user inputs an incorrect constraint condition, an optimization problem which is supposed to have a solution does not have a solution, in some cases. Thus, a debugging task is important for determining whether the constraint condition imposed on the optimization problem is proper.

Such a debugging task has manually been carried out. This causes a problem of having the possibility that the quality of determination on whether a constraint condition is proper depends on a factor which relies on a particular individual. In addition, there is a problem of taking more time to carry out the debugging task for more constraint conditions imposed on an optimization problem.

An example aspect of the present invention has been made in view of the above problems, and an example object thereof is to provide a debugging apparatus capable of automatically and efficiently carrying out the task of debugging constraint conditions imposed on an optimization problem.

### Solution to Problem

A debugging apparatus in accordance with an example aspect of the present invention, includes: a dividing means for, in a case where there is no solution to an optimization problem under a plurality of constraint conditions, dividing the plurality of constraint conditions into a plurality of groups; and a determining means for determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

A debugging method in accordance with an example aspect of the present invention includes: a debugging apparatus dividing, in a case where there is no solution to an optimization problem under a plurality of constraint conditions, the plurality of constraint conditions into a plurality of groups; and the debugging apparatus determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

A program in accordance with an example aspect of the present invention is a program for causing a computer to function as a debugging apparatus, and the program causes the computer to function as: a dividing means for, in a case where there is no solution to an optimization problem under a plurality of constraint conditions, dividing the plurality of constraint conditions into a plurality of groups; and a determining means for determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

### Advantageous Effects of Invention

With an example aspect of the present invention, it is possible to automatically and efficiently carry out the task of debugging constraint conditions imposed on an optimization problem.

### BRIEF DESCRIPTION OF DRAWINGS

FIG. 1 is a block diagram illustrating a configuration of a debugging apparatus in accordance with a first example embodiment.

FIG. 2 is a flowchart illustrating a flow of a debugging method in accordance with the first example embodiment.

FIG. 3 is a block diagram illustrating a configuration of a debugging apparatus in accordance with a second example embodiment.

FIG. 4 is a flowchart illustrating a flow of a debugging method in accordance with the second example embodiment.

FIG. 5 is a block diagram illustrating a configuration of a debugging apparatus in accordance with a third example embodiment.

FIG. 6 is a flowchart illustrating a flow of a debugging method in accordance with the third example embodiment.

FIG. 7 is a block diagram illustrating a configuration of an optimization apparatus in accordance with a first example reference embodiment.

FIG. 8 is a flowchart illustrating a flow of an optimization method in accordance with the first example reference embodiment.

FIG. 9 is a block diagram illustrating a configuration of an optimization apparatus in accordance with a second example reference embodiment.

FIG. 10 is a flowchart illustrating a flow of an optimization method in accordance with the second example reference embodiment.

FIG. 11 is a block diagram illustrating a configuration of a constraint condition evaluation apparatus in accordance with a third example reference embodiment.

FIG. 12 is a flowchart illustrating a configuration of a constraint condition evaluation method in accordance with the third example reference embodiment.

FIG. 13 is a block diagram illustrating a configuration of a computer which functions as the debugging apparatuses in accordance with the example reference embodiments or the optimization apparatuses in accordance with the example embodiments.

### EXAMPLE EMBODIMENTS

### [Optimization Problem]

Debugging apparatuses in accordance with the example embodiments described later and the optimization apparatuses in accordance with the example reference embodiments are for determining an improper constraint condition to debug constraint conditions imposed on an optimization problem. Examples of an optimization problem of interest are supposed to include, but are not limited to, the following optimization problems.

### (Optimization Problem)

A problem of finding an element (x₁, x₂, . . . , x_{Γ}) X that maximizes an objective function f (x₁, x₂, . . . , x_{Γ}) in a solution space X is referred to as an “optimization problem”. The solution space X is a set of elements (x₁, x₂, . . . , x_{Γ}) that satisfy constraint conditions C1, C2, . . . , Cm. Each constraint condition Ci (i=1, 2, . . . , m) is expressed by a mathematical expression (e.g., an equality or an inequality) that includes some or all of the variables x₁, x₂, . . . , x_{Γ}.

Maximizing and minimizing the objective function f (x₁, x₂, . . . , x_{Γ}) are equivalent to each other via an obvious transformation. Specifically, the optimization problem of minimizing the objective function f (x₁, x₂, . . . , x_{Γ}) is the optimization problem of maximizing a new objective function −f (x₁, x₂, . . . , x_{Γ}) obtained by multiplying the objective function f by −1.

### (Linear Programming Problem, Integer Linear Programming Problem, Mixed Integer Linear Programming Problem)

Among optimization problems in which an objective function and a constraint condition become linear with respect to all variables, an optimization problem in which variables x₁, x₂, . . . , x_{Γ} are continuous variables (real number variables) is referred to as a “linear programming problem”, and an optimization problem in which variables x₁, x₂, . . . , x_{Γ} are discrete variables (integer variables) is referred to as an “integer linear programming problem”. Among optimization problems in which an objective function and a constraint condition become linear with respect to all variables, an optimization problem in which both a continuous variable and a discrete variable are included in variables x₁, x₂, . . . , x_{Γ} is referred to as a “mixed integer linear programming problem”.

### (Quadratic Unconstrained Binary Optimization Problem)

A problem of finding an element (x₁, x₂, . . . , x_{Γ}) X that maximizes the objective function f (x₁, x₂, . . . , x_{Γ}) indicated below is referred to as a “quadratic unconstrained binary optimization problem”. The variables x₁, x₂, . . . , x_{Γ} are binary variables each taking a value of 0 or 1. In the quadratic unconstrained binary optimization problem, a constraint condition cannot be directly dealt with. However, it is possible to approximately deal with a constraint condition by adding a term corresponding to the constraint condition to the objective function.

$$f ( {x}_{1} , {x}_{2} , … , {x}_{r} ) = {\sum }_{γ \neq δ} {Q}_{γδ} {x}_{γ} {x}_{δ}$$

### First Example Embodiment

The following description will discuss a first example embodiment of the present invention in detail with reference to the drawings. The present example embodiment is basic to example embodiments which will be described later.

### (Configuration of Debugging Apparatus)

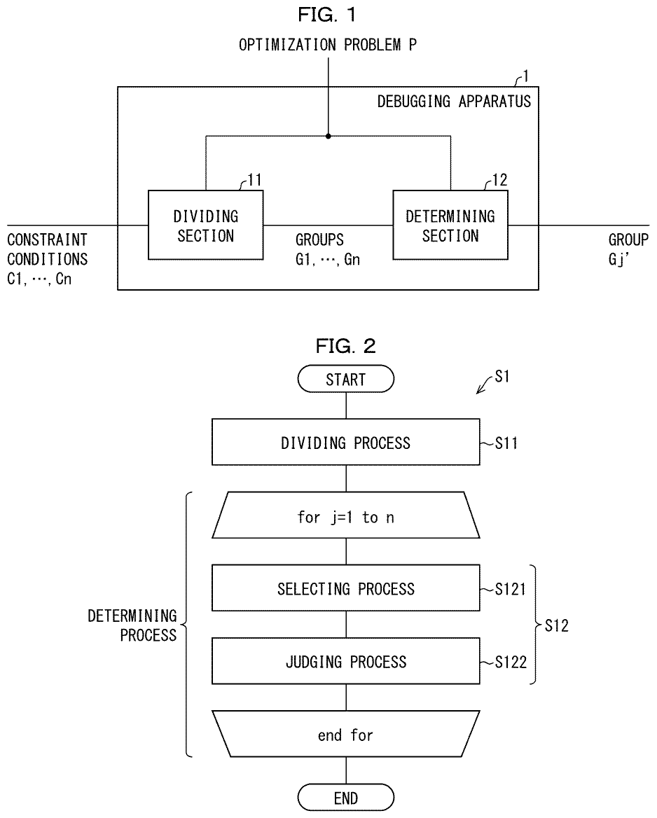

The configuration of a debugging apparatus 1 in accordance with the present example embodiment is described here with reference to FIG. 1. FIG. 1 is a block diagram illustrating the configuration of the debugging apparatus 1.

The debugging apparatus 1 is for debugging the plurality of constraint conditions C1, C2, . . . , Cm imposed on an optimization problem P. The index m is any natural number which represents the number of constraint conditions and which is not less than 2.

The debugging apparatus 1 includes a dividing section 11 and a determining section 12, as illustrated in FIG. 1. The dividing section 11 and the determining section 12 are components that implement the dividing means and the determining means, respectively, in the present example embodiment.

The dividing section 11 is means for dividing the plurality of constraint conditions C1, C2, . . . , Cm into a plurality of groups G1, G2, . . . , Gn, in a case where there is no solution to the optimization problem P under the plurality of constraint conditions C1, C2, . . . , Cm. The index n is a natural number which represents the number of groups and which is not less than 2 but less than m.

The determining section 12 is means for determining a group Gj′ the exclusion of which causes the optimization problem P to have a solution. The determining section 12 repeatedly carries out, for each j which is not less than 1 and not more than n, a selecting process (1) of selecting at least one group (a single group Gj′ here, and n′ groups selected from m groups G1, G2, . . . , Gn in a variation described later) from the plurality of groups G1, G2, . . . , Gn and a judging process (2) of judging whether there is a solution to the optimization problem P under a constraint condition which is included in the plurality of constraint conditions C1, C2, . . . , Cm and which is included in the groups G1, G2, . . . , Gj−1, Gj+1, . . . , Gn other than the group Gj′ selected. A group determined by the determining section 12 as the group Gj′ the exclusion of which causes the optimization problem P to have a solution is such that there is no solution to the optimization problem P under a constraint condition which belongs to groups G1, G2, . . . , Gj′−1, Gj′+1, . . . , Gn other than the group Gj′.

The optimization problem P may be the optimization problem that is known in advance to have no solution under the plurality of constraint conditions C1, C2, . . . , Cm, or may be the optimization problem that is not known in advance to have no solution under the plurality of constraint conditions C1, C2, . . . , Cm. In the latter case, the dividing section 11 may carry out a judging process of judging whether there is a solution to the optimization problem P under the plurality of constraint conditions C1, C2, . . . , Cm, before carrying out the dividing process of dividing the plurality of constraint conditions C1, C2, . . . , Cm into the plurality of groups G1, G2, . . . , Gn.

### (Flow of Debugging Method)

The flow of a debugging method S1 in accordance with the present example embodiment is described here with reference to FIG. 2. FIG. 2 is a flowchart illustrating the flow of the debugging method S1.

The debugging method S1 is for debugging the plurality of constraint conditions C1, C2, . . . , Cm that are imposed on the optimization problem P. In the present example embodiment, the debugging method S1 is carried out by the debugging apparatus 1.

The debugging method S1 includes a dividing process S11 and a determining process S12, as illustrated in FIG. 2.

The dividing process S11 is for dividing a plurality of constraint conditions C1, C2, . . . , Cm into a plurality of groups G1, G2, . . . , Gn in a case where there is no solution to the optimization problem P under the plurality of constraint conditions C1, C2, . . . , Cm. In the debugging apparatus 1 in accordance with the present example embodiment, the dividing process S11 is carried out by the dividing section 11.

The determining process S12 is for determining a group Gj′ the exclusion of which causes the optimization problem P to have a solution. In the determining process S12, a selecting process (1) S121 of selecting a group Gi from a plurality of groups G1, G2, . . . , Gn and a judging process (2) S122 of judging whether there is a solution to the optimization problem P under a constraint condition which is included in the plurality of constraint conditions C1, C2, . . . , Cm and which belongs to the groups G1, G2, . . . , Gj−1, Gj+1, . . . , Gn other than the group Gi selected, are repeatedly carried out for each j which is not less than 1 and not more than n. The group Gj′ determined in the determining process S12 as the group Gj′ the exclusion of which causes the optimization problem P to have a solution is such that there is no solution to the optimization problem P under a constraint condition which belongs to groups G1, G2, . . . , Gj′−1, Gj′+1, . . . , Gn other than the group Gj′. In the debugging apparatus 1 in accordance with the present example embodiment, the determining process S12 is carried out by the determining section 12.

The optimization problem P may be the optimization problem that is known in advance to have no solution under the plurality of constraint conditions C1, C2, . . . , Cm, or may be the optimization problem that is not known in advance to have no solution under the plurality of constraint conditions C1, C2, . . . , Cm. In the latter case, a judging process of judging whether there is a solution to the optimization problem P under the plurality of constraint conditions C1, C2, . . . , Cm may be carried out before the dividing process S11 of dividing the plurality of constraint conditions C1, C2, . . . , Cm into the plurality of groups G1, G2, . . . , Gn is carried out.

### (Example Advantage of Debugging Apparatus and Debugging Method)

In conventional debugging apparatuses, a judgment is made for each constraint condition Ci (1≤i≤m) on whether the constraint condition Ci is an improper constraint condition. In contrast, in the debugging apparatus 1 in accordance with the present example embodiment, a judgment is made for each group Gj′ (1≤j≤n) on whether the group Gj′ includes an improper constraint condition. Thus, in conventional debugging apparatuses, the number of times an optimization problem is solved until the completion of the judgments is m, whereas in the debugging apparatus 1 in accordance with the present example embodiment, the number of times the optimization problem is solved until the completion of judgments is n.

As described above, the number n of the groups G1, G2, . . . , Gn is smaller than the number m of the constraint condition C1, C2, . . . , Cm. Thus, with the debugging apparatus 1 in accordance with the present example embodiment, it is possible to reduce the number of times an optimization problem is solved until the completion of the judgments, as compared with conventional debugging apparatuses. As a result, with the debugging apparatus 1 in accordance with the present example embodiment, it is possible to reduce the time required for the completion of the judgments, as compared with conventional debugging apparatuses. The debugging method S1 in accordance with the present example embodiment provides a similar example advantage.

### (Specific Examples of Dividing Process)

Several specific examples of the dividing process S11 are described here.

In a case where the number pⱼ of constraint conditions to be included in each group Gj′ is determined in advance, there are possible specific examples as described below.

Specific example 1: constraint conditions to be included in each group Gj′ are determined on the basis of the index i of each constraint condition Ci. For example, constraint conditions C1 to Cp₁ are included in the group G1, and constraint conditions Cp₁+1 to Cp₁+p₂ are included in the group G2. Constraint conditions to be included in the groups G3 to Gn are determined in a similar manner.

Specific example 2: constraint conditions to be included in each group Gj′ are randomly determined. For example, p₁ constraint conditions randomly selected from the m constraint conditions are included in the group G1, and p₂ constraint conditions randomly selected from the remaining m-p₁ constraint conditions are included in the group G2. Constraint conditions to be included in the groups G3 to Gn are determined in a similar manner.

In a case of focusing on the content of each constraint condition Ci, there is a possible specific example as described below.

Specific example 3: constraint conditions to be included in each group Gj′ are determined such that constraint conditions of the same type belong to the same group. For example, two constraint conditions which are transformable from one of the two constraint conditions into another by interchange of variables are regarded as the constraint conditions of the same type, and constraint conditions to be included in each group Gj′ are determined such that the constraint conditions of the same type belong to the same group. In this case, examples of the constraint conditions of the same type include a set of “xᵢ+2xᵢ₊₁≥1” and “xᵢ′+2x_{i′+1}≥1” (i≠i′).

### Variation 1

In the present example embodiment, the problem of judging, for each of the m constraint conditions C1 to Cm, whether that constraint condition is improper is studied. However, the scope of the present invention is not limited thereto. That is, the problem of judging, for each of the combinations of m′ constraint conditions selected from the m constraint conditions C1 to Cm, whether that combination is improper is within the scope of the present invention. The number m′ is a specific natural number that satisfies 1<m′ <m. In this case, the number of times the optimization problem is solved in conventional debugging apparatuses reaches m! (m−m′)!/m′!.

In contrast, in the debugging apparatus 1 in accordance with the present example embodiment, a judgment is made, for each of the n′ groups selected from the n groups G1 to Gn, on whether a combination is improper. The number of n′ is a specific natural number that satisfies 1<n′<n. In this case, for each of the combinations of the n′ groups selected from the n groups G1, G2, . . . , Gn, the determining section 12 judges whether there is a solution to the optimization problem P under a constraint condition included in a group other than the groups that constitute that combination. In the debugging apparatus 1 in accordance with the present example embodiment, the number of times the optimization problem is solved is therefore reduced to n! (n−n′)!/n′! (because of n<m, n! (n−n′)!/n′!<<m! (m−m′)!/m′!). Thus, with the debugging apparatus 1 in accordance with the example embodiment, it is possible to significantly reduce the time required for the completion of the judgments, as compared with conventional debugging apparatuses.

The above variation of the present example embodiment is applicable to the example embodiments which will be described later.

### Variation 2

In the present example embodiment, the problem of judging, for each of the m constraint conditions C1 to Cm, whether that constraint condition is improper is studied. However, the scope of the present invention is not limited thereto. That is, the problem of judging, for each of the combinations of any number of constraint conditions selected from the m constraint conditions C1 to Cm, whether that combination is improper is within the scope of the present invention. In this case, the number of times the optimization problem is solved in conventional debugging apparatuses reaches 2^{m}.

In contrast, in the debugging apparatus 1 in accordance with the present example embodiment, a judgment is made, for each of any number of groups selected from the n groups G1 to Gn, on whether a combination is improper. In this case, for each of the combinations of any number of groups selected from the n groups G1, G2, . . . , Gn, the determining section 12 judges whether there is a solution to the optimization problem P under a constraint condition included in a group other than the groups that constitute that combination. In the debugging apparatus 1 in accordance with the present t example embodiment, the number of times the optimization problem is solved is therefore reduced to 2ⁿ (because of n<m, 2ⁿ<<2^{m}). Thus, with the debugging apparatus 1 in accordance with the example embodiment, it is possible to significantly reduce the time required for the completion of the judgments, as compared with conventional debugging apparatuses.

The above variation of the present example embodiment is applicable to the example embodiments which will be described later.

### Variation 3

The debugging apparatus 1 in accordance with the present example embodiment may further include an output section. The output section is a component for presenting, to a user, information indicating the group Gj′ determined by the determining section 12, information indicating the index j′ of the group Gj′, information indicating constraint conditions included in the group Gj′, or information indicating the indexes of the constraint conditions. The output section may output these pieces of information in the form of an image via a display, or may output these pieces of information in the form of voice via a speaker.

The above variation of the present example embodiment is applicable to the example embodiments which will be described later.

### Second Example Embodiment

The following description will discuss a second example embodiment of the present invention in detail with reference to the drawings. A component that has the same function as a component described in the first example embodiment is assigned the same reference sign, and the description thereof is omitted, where appropriate.

In the present example embodiment, in a case where the variables (e.g., the variables of an objective function) to be optimized in the optimization problem P include a discrete variable(s) (e.g., an integer(s)), a relaxation problem P′ obtained by replacing this/these discrete variable(s) with a continuous variable(s) is used for debugging the constraint conditions C1, C2, . . . , Cm. As is mathematically guaranteed, in a case where there is no solution to the relaxation problem P′, there is no solution to the optimization problem P.

### (Configuration of Debugging Apparatus)

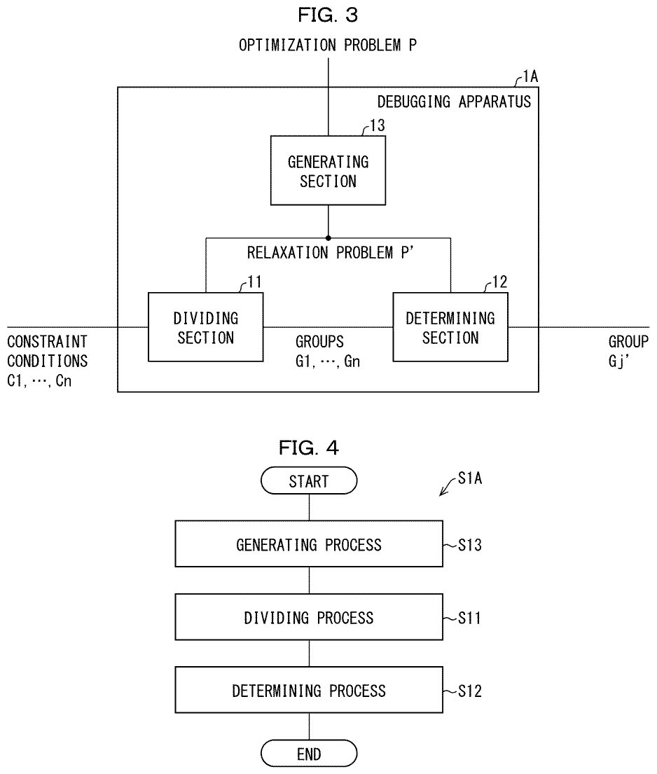

The configuration of a debugging apparatus 1A in accordance with the present example embodiment is described here with reference to FIG. 3. FIG. 3 is a block diagram illustrating the configuration of the debugging apparatus 1A.

The debugging apparatus 1A has a configuration in which a generating section 13 is added to the debugging apparatus 1 in accordance with the first example embodiment. The generating section 13 is a component for implementing the generating means in the present example embodiment.

The generating section 13 is a component for replacing a variable to be optimized which is a discrete variable with a continuous variable, to generate the relaxation problem P′ from the optimization problem P.

The dividing section 11 uses the relaxation problem P′ generated by the generating section 13, to judge whether there is a solution to the optimization problem P under the plurality of constraint conditions C1, C2, . . . , Cm. For example, the dividing section 11 judges whether there is a solution to the relaxation problem P′ under the plurality of constraint conditions C1, C2, . . . , Cm, and if there is no solution to the relaxation problem P′, judges that there is no solution to the optimization problem P. In a case where there is no solution to the relaxation problem P′, the dividing section 11 divides the plurality of constraint conditions C1, C2, . . . , Cm into a plurality of groups G1, G2, . . . , Gn.

Even in a case where there is a solution to the relaxation problem P′, there can be no solution to the optimization problem P. For this reason, in a case where there is a solution to the relaxation problem P′, the dividing section 11 may further judge whether there is a solution to the optimization problem P.

The determining section 12 uses the relaxation problem P′ generated by the generating section 13, to judge whether there is a solution to the optimization problem P under a constraint condition which is included in the plurality of constraint conditions C1, C2, . . . , Cm and which belongs to the groups G1, G2, . . . , Gj−1, Gj+1, . . . , Gn other than the group Gj′. For example, the determining section 12 judges whether there is a solution to the relaxation problem P′ under a constraint condition which is included in the plurality of constraint conditions C1, C2, . . . , Cm and which belongs to the groups G1, G2, . . . , Gj−1, Gj+1, . . . , Gn other than the group Gj′, and if there is no solution to the relaxation problem P′, judges that there is no solution to the optimization problem P.

Even in a case where there is a solution to the relaxation problem P′, there can be no solution to the optimization problem P. Thus, in a case where there is a solution to the relaxation problem P′, the determining section 12 may further judge whether there is a solution to the optimization problem P.

### (Flow of Debugging Method)

The flow of a debugging method SIA in accordance with the present example embodiment is described here with reference to FIG. 4. FIG. 4 is a flowchart illustrating the flow of the debugging method S1A.

The debugging method SIA has a configuration in which a generating process S13 is added to the debugging method S1 in accordance with the first example embodiment.

The generating process S13 is for replacing a variable to be optimized which is a discrete variable in the optimization problem P with a continuous variable, to generate the relaxation problem P′. In the debugging apparatus 1A, the generating process S13 is carried out by the generating section 13.

In the dividing process S11, the relaxation problem P′ generated by the generating process S13 is used to judge whether there is a solution to the optimization problem P under the plurality of constraint conditions C1, C2, . . . , Cm. For example, in the dividing process S11, whether there is a solution to the relaxation problem P′ under the plurality of constraint conditions C1, C2, . . . , Cm is judged, and if there is no solution to the relaxation problem P′, it is judged that there is no solution to the optimization problem P.

Even in a case where there is a solution to the relaxation problem P′, there can be no solution to the optimization problem P. Thus, in a case where there is a solution to the relaxation problem P′, whether there is a solution to the optimization problem P may be further judged in the dividing process S11.

In the determining process S12, with use of the relaxation problem P′ generated by the generating process S13, a judgment is made on whether there is a solution to the optimization problem P under a constraint condition which is included in the plurality of constraint conditions C1, C2, . . . , Cm and which belongs to the groups G1, G2, . . . , Gj−1, Gj+1, . . . , Gn other than the group Gj. For example, in the determining process S12, a judgment is made on whether there is a solution to the relaxation problem P′ under a constraint condition which is included in the plurality of constraint conditions C1, C2, . . . , Cm and which belongs to the groups G1, G2, . . . , Gj−1, Gj+1, . . . , Gn other than the group Gj′, and if there is no solution to the relaxation problem P′, it is judged that there is no solution to the optimization problem P, and if there is no solution to the relaxation problem P′, it is judged that there is no solution to the optimization problem P.

Even in a case where there is a solution to the relaxation problem P′, there can be no solution to the optimization problem P. Thus, in a case where there is a solution to the relaxation problem P′, in the determining process S12, whether there is a solution to the optimization problem P may be further judged.

### (Example Advantage of Debugging Apparatus and Debugging Method)

In the debugging apparatus 1 in accordance with the first example embodiment, the optimization problem P with a discrete variable is solved, whereas in the debugging apparatus 1A in accordance with the present example embodiment, the relaxation problem P′ with a continuous variable is solved. The optimization problem P in which the variables to be optimized includes a discrete variable belongs to the NP hard class, whereas the relaxation problem P′ in which all the variables to be optimized are continuous variables belongs to the P class. Thus, the debugging apparatus 1 in accordance with the present example embodiment provides a further example advantage as follows: it is possible to determine a group which includes an improper constraint condition in a shorter time than with the debugging apparatus 1 in accordance with the first example embodiment, or it is possible to determine a group which includes an improper constraint condition in a realistic amount of time, even in a case where it is impossible for the debugging apparatus 1 in accordance with the first example embodiment to determine the group which includes an improper constraint condition in a realistic amount of time.

### Third Example Embodiment

The following description will discuss a third example embodiment of the present invention in detail with reference to the drawings. Note that a component having the same function as a component described in the first example embodiment is assigned the same reference sign, and the description thereof is omitted where appropriate.

### (Configuration of Debugging Apparatus)

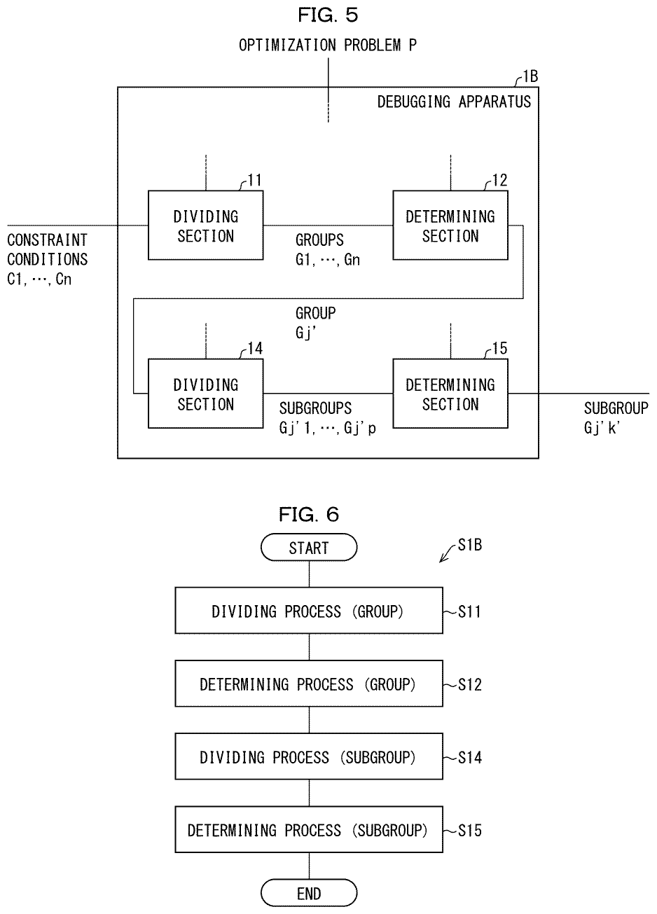

The configuration of a debugging apparatus 1B in accordance with the present example embodiment is described here with reference to FIG. 5. FIG. 5 is a block diagram illustrating the configuration of the debugging apparatus 1B.

The debugging apparatus 1B has a configuration in which a dividing section 14 and a determining section 15 are added to the debugging apparatus 1 in accordance with the first example embodiment.

The dividing section 14 is means for dividing constraint conditions which are included in a plurality of constraint conditions C1, C2, . . . , Cm and which belong to a group Gj′ determined by the determining section 12 into a plurality of subgroups Gj′1, Gj′2, . . . , Gj′q. Given that the number of constraint conditions included in the group Gj′ is p, the number q of subgroups is a natural number which is not less than 2 and not more than p. In a case of q=p, each subgroup Gj′k includes a single constraint condition. In this case, each subgroup Gj′k can be equated with the constraint condition included in that subgroup Gj′k.

The determining section 15 is means for determining a subgroup Gj′k the exclusion of which causes the optimization problem P to have a solution. The determining section 12 repeatedly carries out, for each k which is not less than 1 and not more than q, a selecting process (1) of selecting a single subgroup Gi′k from the plurality of subgroups Gj′1, Gj′2, . . . , Gj′q and a judging process (2) of judging whether there is a solution to the optimization problem P under a constraint condition which is included in the plurality of constraint conditions C1, C2, . . . , Cm and which is included in subgroups Gi′1, Gi′2, . . . , Gi′k−1, Gi′k+1, . . . , Gi′q other than the subgroup Gi′k selected. The subgroup determined by the determining section 15 as the subgroup Gi′k′ the exclusion of which causes the optimization problem P to have a solution is such that there is no solution to the optimization problem P under a constraint condition which is included in the subgroups Gi′1, Gi′2, . . . , Gi′k′−1, Gi′k′+1, . . . , Gi′q other than the subgroup Gi′k′.

### (Flow of Debugging Method)

The flow of a debugging method S1B in accordance with the present example embodiment is described here with reference to FIG. 6. FIG. 6 is a flowchart illustrating the flow of the debugging method S1B.

The debugging method S1B has a configuration in which a dividing process S14 and a determining process S15 are added to the debugging method S1 in accordance with the first example embodiment.

The dividing process S14 is for dividing the constraint conditions which are included in the plurality of constraint conditions C1, C2, . . . , Cm and which belong to the group Gj′ determined by the determining process S12 into the plurality of subgroups Gj′1, Gj′2, . . . , Gj′q. Given that the number of constraint conditions included in the group Gj′ is p, the number q of subgroups is a natural number which is not less than 2 and not more than p. In a case of q=p, each subgroup Gj′k includes a single constraint condition. In this case, each subgroup Gj′k can be equated with the constraint condition included in that subgroup Gj′k. In the debugging apparatus 1B, the dividing process S14 is carried out by the dividing section 14.

The determining process S15 is for determining the subgroup Gi′k′ the exclusion of which causes the optimization problem P to have a solution. In the determining process S15, a selecting process (1) of selecting a single subgroup Gi′k from the plurality of subgroups Gj′1, Gj′2, . . . , Gj′q and a judging process (2) of judging whether there is a solution to the optimization problem P under a constraint condition which is included in the plurality of constraint conditions C1, C2, . . . , Cm and which is included in subgroups Gi′1, Gi′2, . . . , Gi′k−1, Gi′k+1, . . . , Gi′q other than the subgroup Gi′k selected are repeatedly carried out for each k which is not less than 1 and not more than q. The subgroup determined by the determining process S15 as the subgroup Gi′k′ the exclusion of which causes the optimization problem P to have a solution is such that there is no solution to the optimization problem P under a constraint condition which is included in the subgroups Gi′1, Gi′2, . . . , Gi′k′−1, Gi′k′+1, . . . , Gi′q other than the subgroup Gi′k′. In the debugging apparatus 1B, the determining process S15 is carried out by the determining section 15.

### (Example Advantage of Debugging Apparatus and Debugging Method)

In the debugging apparatus 1 in accordance with the first example embodiment, a judgment on whether the constraint condition is proper is made in units of groups, whereas in the debugging apparatus 1 in accordance with the present example embodiment, a judgment on whether the constraint condition is proper is made in units of subgroups.

Thus, the debugging apparatus 1B in accordance with the present example embodiment provides a further example advantage as follows: it is possible to judge whether a constraint condition is proper in finer units (units of subgroups) than with the debugging apparatus 1B in accordance with the first example embodiment.

### First Example Reference Embodiment

The following description will discuss a first example reference embodiment of the present invention in detail with reference to the drawings. The present example reference embodiment is basic to example reference embodiments which will be described later.

### (Configuration of Optimization Apparatus)

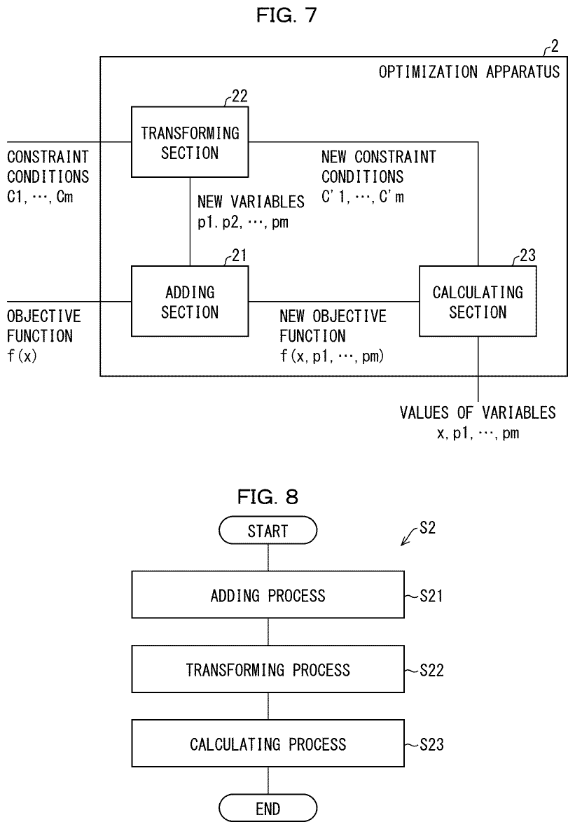

The configuration of an optimization apparatus 2 in accordance with the present example reference embodiment is described here with reference to FIG. 7. FIG. 7 is a block diagram illustrating the configuration of the optimization apparatus 2.

The optimization apparatus 2 is for solving an optimization problem of maximizing or minimizing the value of an objective function f(x) under m constraint conditions C1, C2, . . . , Cm, where m is any natural number. Here, m is any natural number, and x=(x₁, x₂, . . . , x_{Γ}) is a variable vector. For example, the constraint condition Ci is an inequality Aix+bi≥0. In the inequality, i represents the natural number of not less than 1 and not more than m, Ai is a coefficient matrix, and bi is a coefficient vector. In other words, in each of the constraint conditions, the sum of the coefficient matrix and the coefficient vector is a non-negative value.

The optimization apparatus 2 includes an adding section 21, a transforming section 22, and a calculating section 23.

The adding section 21 is a component for adding, to the objective function f(x), a corresponding new variable pi (i is a natural number of not less than 1 and not more than m) of each constraint condition Ci, to generate a new objective function f′(x, p1, p2, . . . , pm). The objective function f(x) is also referred to as a first objective function, and the new objective function f′(x, p1, p2, . . . , pm) is also referred to as a second objective function. That is, the adding section 21 is a component for adding, to the first objective function, one or more new variables which individually correspond to one or more constraint conditions, to generate the second objective function.

For example, the new objective function f′(x, p1, p2, . . . , pm) is f′(x, p1, p2, . . . , pm)=f(x)+p1+p2+ . . . +pm. In other words, the second objective function is the sum of the first objective function and the new variable.

The transforming section 22 is a component for transforming each constraint condition Ci into a corresponding new constraint condition C′i to be imposed on the corresponding new variable pi. In other words, the transforming section 22 is a component for transforming each constraint condition into a corresponding new constraint condition to be imposed on the corresponding new variable.

For example, the new constraint condition C′i is as follow: the inequality pi≥0; and the inequality pi≥−Aix+bi. In other words, the new constraint condition is such that the corresponding new variable is non-negative, and the new constraint condition is represented by an inequality in which the linear sum of the coefficient matrix, the variable, and the coefficient vector is used.

The calculating section 23 is a component for calculating the values of the variable x and each new variable pi of the new objective function f′(x, p1, p2, . . . , pm), the values maximizing or minimizing the new objective function f′(x, p1, p2, . . . , pm) under new constraint conditions C′1, C′2, . . . , C′m. In other words, the calculating section 23 is a component for calculating the values of the variable and each new variable of the second objective function, the values maximizing or minimizing the second objective function under the new constraint conditions.

### (Flow of Optimization Method)

The flow of an optimization method S2 in accordance with the present example reference embodiment is described here with reference to FIG. 8. FIG. 8 is a flowchart illustrating the flow of the optimization method S2.

The optimization method S2 is for solving an optimization problem of maximizing or minimizing the value of the objective function f(x) under the m constraint conditions C1, C2, . . . , Cm. In the present example reference embodiment, the optimization method S2 is carried out by the optimization apparatus 2.

The optimization method S2 includes an adding process S21, a transforming process S22, and a calculating process S23, as illustrated in FIG. 8.

The adding process S21 is for adding, to the objective function f(x), a corresponding new variable pi of each constraint condition Ci, to generate the new objective function f′(x, p1, p2, . . . , pm). In other words, the adding process S21 is for adding, to the first objective function, one or more new variables which individually correspond to one or more constraint conditions, to generate the second objective function. For example, the new objective function f′(x, p1, p2, . . . , pm) is f′(x, p1, p2, . . . , pm)=f(x)+p1+p2+ . . . +pm. In the present example reference embodiment, the adding process S21 is carried out by the adding section 21 of the optimization apparatus 2.

The transforming process S22 is for transforming each constraint condition Ci into a corresponding new constraint condition C′i to be imposed on the corresponding new variable pi. In other words, the transforming process S22 is for transforming each constraint condition into a corresponding new constraint condition to be imposed on the corresponding new variable pi. For example, the new constraint condition C′i is as follow: the inequality pi≥0; and the inequality pi≥−Aix+bi. In the present example reference embodiment, the transforming process S22 is carried out by the transforming section 22 of the optimization apparatus 2.

The calculating process S23 is for calculating the values of the variable x and each new variable pi of the new objective function f′(x, p1, p2, . . . , pm), the values maximizing or minimizing the new objective function f′(x, p1, p2, . . . , pm) under new constraint conditions C′1, C′2, . . . , C′m. In other words, the calculating process S23 is for calculating the values of the variable and each new variable of the second objective function, the values maximizing or minimizing the second objective function under the new constraint conditions. In the present example reference embodiment, the calculating process S23 is carried out by the calculating section 23 of the optimization apparatus 2.

### (Example Advantage of Optimization Apparatus and Optimization Method)

The optimization problem of maximizing or minimizing the value of the new objective function f′(x, p1, p2, . . . , pm) under the new constraint conditions C′1, C′2, . . . , C′m becomes a relaxation problem of the optimization problem of maximizing or minimizing the value of the original objective function f (p1, p2, . . . , pm) under the original constraint conditions C1, C2, . . . , Cm. Accordingly, the optimization problem of maximizing or minimizing the value of the new objective function f′(x, p1, p2, . . . , pm) under the new constraint conditions C′1, C′2, . . . , C′m definitely has a solution. Thus, with the optimization apparatus 2 in accordance with the present example reference embodiment, an approximate solution (a solution obtained by applying the constraint conditions C1, C2, . . . , Cm in a relaxed manner) is always obtained even in a case where the optimization problem of maximizing or minimizing the value of the original objective function f (p1, p2, . . . , pm) has no solution under the original constraint conditions C1, C2, . . . , Cm.

The value of the new variable pi which maximizes or minimizes the value of the new objective function f′(x, p1, p2, . . . , pm) represents the degree of non-compliance with the corresponding constraint condition Ci. Thus, with the optimization apparatus 2 in accordance with the present example reference embodiment, it is possible to obtain the degree of non-compliance with each constraint condition Ci, together with the approximate solution described above.

The optimization method S2 in accordance with the present example reference embodiment provides an example advantage similar to that provided by the optimization apparatus 2 in accordance with the present example reference embodiment.

### Second Example Reference Embodiment

The following description will discuss a second example reference embodiment of the present invention in detail with reference to the drawings. Note that a component having the same function as a component described in the first example reference embodiment is assigned the same reference sign, and the description thereof is omitted where appropriate.

### (Configuration of Optimization Apparatus)

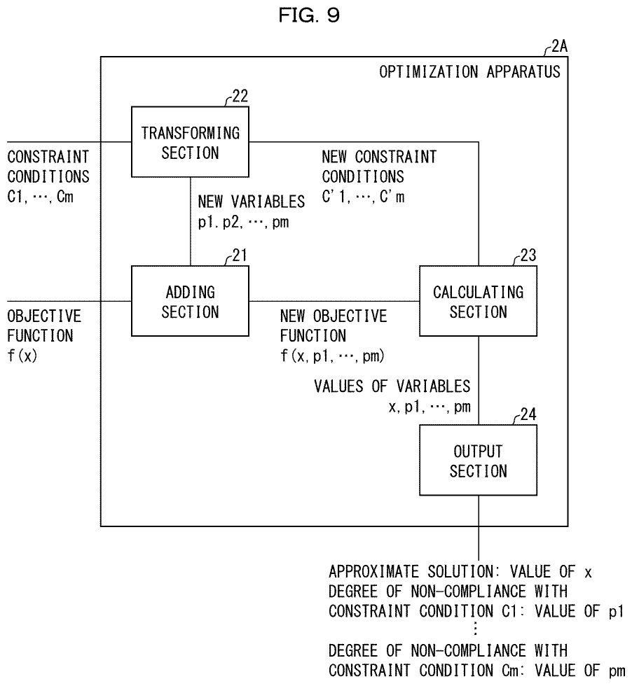

The configuration of an optimization apparatus 2A in accordance with the present example reference embodiment is described here with reference to FIG. 9. FIG. 9 is a block diagram illustrating the configuration of the optimization apparatus 2A.

The optimization apparatus 2A has a configuration in which an output section 24 is added to the optimization apparatus 2 in accordance with the first example reference embodiment.

The output section 24 is a component for outputting, from among the values calculated by the calculating section 23, the value of the variable vector x, which is other than the new variables p1, p2, . . . , pm, as an approximate solution to the optimization problem of maximizing or minimizing the value of the objective function f(x) under the constraint conditions C1, C2, . . . , Cm. Further, the output section 24 is a component for outputting, from among the values calculated in the calculating section 23, the value of each new variable pi, as the degree of non-compliance with the corresponding constraint condition Ci. The output section 24 may output these values in the form of an image via a display, or may output these values in the form of voice via a speaker.

### (Flow of Optimization Method)

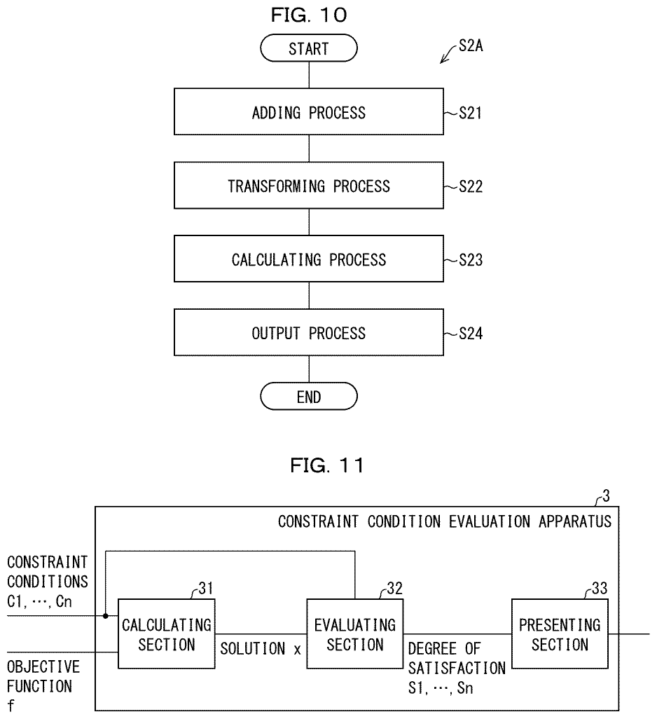

The configuration of an optimization method S2A in accordance with the present example reference embodiment is described here with reference to FIG. 10. FIG. 10 is a flowchart illustrating the flow of the optimization method S2A.

The optimization method S2A has a configuration in which an output process S24 is added to the optimization method S2 in accordance with the first example reference embodiment.

The output process S24 is for outputting, from among the values calculated in the calculating process S23, the value of the variable vector x, as an approximate solution to the optimization problem of maximizing or minimizing the value of the objective function f(x) under the constraint conditions C1, C2, . . . , Cm. Further, the output process S24 is for outputting, from among the values calculated in the calculating process S23, the value of each new variable pi, as the degree of non-compliance with the corresponding constraint condition Ci. In the output process S24, these values may be outputted in the form of an image via a display, or may be outputted in the form of voice via a speaker.

### (Example Advantage of Optimization Apparatus and Optimization Method)

The optimization apparatus 2A in accordance with the present example reference embodiment provides a further example advantage of making it possible to let a user know about an approximate solution to the optimization problem of maximizing or minimizing the value of the objective function f(x) under the constraint conditions C1, C2, . . . , Cm, together with the degree of non-compliance with each constraint condition Ci. The optimization method S2A in accordance with the present example reference embodiment also provide a further example advantage similar to that provided by the optimization apparatus 2A in accordance with the present example reference embodiment.

### Combination of Example Embodiment and Example Reference Embodiment

In the debugging apparatus 1, an optimization problem is solved in the dividing section 11 and the determining section 12, in order to judge whether there is a solution or not. In doing so, the optimization apparatus 2 can be used as a solver for solving the optimization problem. In this case, for example, the dividing section 11 and the determining section 12 judge that there is a solution to an optimization problem in a case where the degree of non-compliance is 0 for all the constraint conditions, and judge that there is no solution to the optimization problem in a case where the degree of non-compliance is not 0 for any one of the constraint conditions. Alternatively, the dividing section 11 and the determining section 12 judge that there is no solution to the optimization problem in a case where the degree of non-compliance is smaller than a predetermined threshold for all the constraint conditions, and judge that there is a solution to the optimization problem in a case where the degree of non-compliance is greater than the predetermined threshold for any one of the constraint conditions.

### Third Example Reference Embodiment

### (Configuration of Constraint Condition Evaluation Apparatus)

The configuration of a constraint condition evaluation apparatus 3 in accordance with the present example reference embodiment is described here with reference to FIG. 11. FIG. 11 is a block diagram illustrating the configuration of the constraint condition evaluation apparatus 3.

The constraint condition evaluation apparatus 3 is for evaluating the degree Si of satisfaction, which indicates, for each constraint condition Ci, a degree to which a solution to an optimization problem of maximizing or minimizing the value of the objective function f(x) under the m constraint conditions C1, C2, . . . , Cm satisfies the constraint condition Ci. Here, m is any natural number, i is each natural number of not less than 1 and not more than m, and x=(x₁, x₂, . . . , x_{Γ}) is a variable vector. The constraint condition Ci to be evaluated is the constraint condition which is included in the m constraint conditions C1, C2, . . . , Cm and which can be represented in the form of gi(x)≥0.

The constraint condition evaluation apparatus 3 includes a calculating section 31, an evaluating section 32, and a presenting section 33, as illustrated in FIG. 11.

The calculating section 31 is a component for calculating the value of the variable x which maximizes or minimizes the value of the objective function f(x) under the m constraint conditions C1, C2, . . . , Cm. That is, the calculating section 31 is for solving an optimization problem.

The evaluating section 32 is a component for calculating the degree Si of satisfaction for each constraint condition Ci which is included in the m constraint conditions C1, C2, . . . , Cm and which can be represented in the form of gi(x)≥0. The evaluating section 32 calculates the degree Si of satisfaction by, for example, substituting the value of the variable x (i.e., a solution to the optimization problem) calculated by the calculating section 31 into gi(x) which appears in the left side of the constraint condition Ci.

The presenting section 33 is a component presenting, to a user, for each constraint condition Ci which is included in the m constraint conditions C1, C2, . . . , Cm and which can be represented in the form of gi(x)≥0, the degree Si of satisfaction calculated by the evaluating section 32 or an indicator calculated from the degree Si of satisfaction. For example, the presenting section 33 displays the m constraint conditions C1, C2, . . . , Cm on a display such that these constraint conditions are sorted in descending or ascending order of the degree Si of satisfaction. Alternatively, the presenting section 33 creates a graph (e.g., pie chart) which indicates the corresponding degree Si of satisfaction of each constraint condition Ci and displays the created graph on the display. Alternatively, the presenting section 33 creates a heat map which indicates the corresponding degree Si of satisfaction of each constraint condition Ci and displays the created graph on the display.

### (Flow of Constraint Condition Evaluation Method)

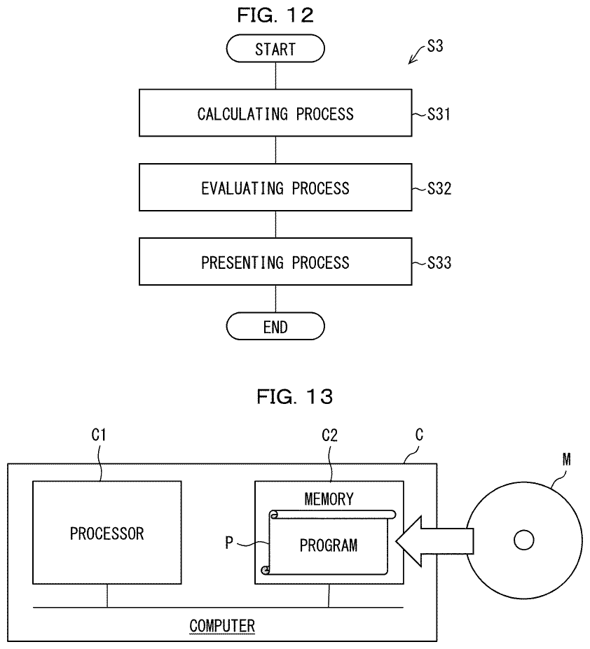

The flow of a constraint condition evaluation method S3 in accordance with the present example reference embodiment is described here with reference to FIG. 12. FIG. 12 is a flowchart illustrating the flow of the constraint condition evaluation method S3.

The constraint condition evaluation method S3 is for evaluating the degree Si of satisfaction which indicates, for each constraint condition Ci, a degree to which a solution to an optimization problem of maximizing or minimizing the value of the objective function f(x) under the m constraint conditions C1, C2, . . . , Cm satisfies the constraint condition Ci. In the present example reference embodiment, the constraint condition evaluation method S3 is carried out by the constraint condition evaluation apparatus 3.

The constraint condition evaluation method S3 includes a calculating process S31, an evaluating process t, and a presenting process S33, as illustrated in FIG. 12.

The calculating process S31 is for calculating the value of the variable x which maximizes or minimizes the value of the objective function f(x) under the m constraint conditions C1, C2, . . . , Cm. That is, the calculating process S31 is for solving an optimization problem. In the constraint condition evaluation apparatus 3 in accordance with the present example reference embodiment, the calculating process S31 is carried out by the calculating section 31.

The evaluating process S32 is for calculating the degree Si of satisfaction for each constraint condition Ci which is included in the m constraint conditions C1, C2, . . . , Cm and which can be represented in the form of gi(x)≥0. In the evaluating process S32, the degree Si of satisfaction is calculated by, for example, substituting the value of the variable x (i.e., a solution to the optimization problem) calculated in the calculating process S31 into gi(x) which appears in the left side of the constraint condition Ci. In the constraint condition evaluation apparatus 3 in accordance with the present example reference embodiment, the evaluating process S32 is carried out by the evaluating section 32.

The presenting process S33 is for presenting, to a user, for each constraint condition Ci which is included in the m constraint conditions C1, C2, . . . , Cm and which can be represented in the form of gi(x)≥0, the degree Si of satisfaction calculated in the evaluating process S32 or an indicator calculated from the degree Si of satisfaction. For example, in the presenting process S33, the m constraint conditions C1, C2, . . . , Cm are displayed on a display so as to be sorted in descending or ascending order of the degree Si of satisfaction. Alternatively, in the presenting process S33, a graph (e.g. pie chart) which indicates the corresponding degree Si of satisfaction of each constraint condition Ci is created, and the created graph is displayed on the display. Alternatively, in the presenting process S33, a heat map which indicates the corresponding degree Si of satisfaction of each constraint condition Ci is created, and the created graph is displayed on the display. In the constraint condition evaluation apparatus 3 in accordance with the present example reference embodiment, the presenting process S33 is carried out by the presenting section 33.

### (Example Advantage of Constraint Condition Evaluation Apparatus and Constraint Condition Evaluation Method)

The above-described degree Si of satisfaction of the constraint condition Ci becomes a greater value in a case where a solution to an optimization problem satisfies the constraint condition Ci by a wide margin, and becomes a smaller value in case where a solution to the optimization problem satisfies the constraint condition Ci by a slim margin. With the constraint condition evaluation apparatus 3 in accordance with the present example reference embodiment, it is possible to present, to a user, the degree Si of satisfaction which has such a characteristic. This enables the user to decide, with reference to the degree Si of satisfaction, whether each constraint condition Ci is a proper constraint or an improper constraint condition. With this configuration, it is possible to efficiently proceed with the task of debugging the constraint conditions C1, C2, . . . , Cm.

### Software Implementation Example

Some or all of the functions of the debugging apparatuses 1, 1A, and 1B, the optimization apparatuses 2 and 2A, and the constraint condition evaluation apparatus 3 may be implemented by hardware such as an integrated circuit (IC chip), or may be implemented by software.

In the latter case, the debugging apparatuses 1, 1A, and 1B, the optimization apparatuses 2 and 2A, and the constraint condition evaluation apparatus 3 are provided by, for example, a computer that executes instructions of a program that is software implementing the foregoing functions. An example (hereinafter, computer C) of such a computer is illustrated in FIG. 13. The computer C includes at least one processor C1 and at least one memory C2. The memory C2 stores a program P for causing the computer C to operate as the debugging apparatuses 1, 1A, and 1B, the optimization apparatuses 2 and 2A, and the constraint condition evaluation apparatus 3. The processor C1 of the computer C retrieves the program P from the memory C2 and executes the program P, so that the functions of the debugging apparatuses 1, 1A, and 1B, the optimization apparatuses 2 and 2A, and the constraint condition evaluation apparatus 3 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory, tangible recording medium M capable of being read by the computer C. The recording medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can obtain the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### Supplementary Note 1

A debugging apparatus, including: a dividing means for, in a case where there is no solution to an optimization problem under a plurality of constraint conditions, dividing the plurality of constraint conditions into a plurality of groups; and a determining means for determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

### Supplementary Note 2

The debugging apparatus described in supplementary note 1, further including a generating means for generating a relaxation problem which has, in a form of a continuous variable, a variable to be optimized in the optimization problem, in which in a case where there is no solution to the relaxation problem under the plurality of constraint conditions, the dividing means is configured to divide the plurality of constraint conditions into a plurality of groups.

### Supplementary Note 3

The debugging apparatus described in supplementary note 1 or 2, in which the dividing means is configured to divide the plurality of constraint conditions into a plurality of groups such that constraint conditions of the same type belong to the same group.

### Supplementary Note 4

The debugging apparatus described in supplementary note 3, in which the dividing means is configured to regard, as the constraint conditions of the same type, two constraint conditions which have the same number of variables and which are transformable from one of the two constraint conditions into another by interchange of variables.

### Supplementary Note 5

The debugging apparatus described in any one of supplementary notes 1 to 4, in which the dividing means is configured to divide a plurality of constraint conditions included in a group determined by the determining means into a plurality of subgroups, and the determining means is configured to determine a subgroup exclusion of which causes the optimization problem to have a solution, by repeatedly carrying out a process of selecting one subgroup from the plurality of subgroups to judge whether there is a solution to the optimization problem under a constraint condition included in a subgroup other than the one subgroup selected.

### Supplementary Note 6

A debugging method, including: a debugging apparatus dividing, in a case where there is no solution to an optimization problem under a plurality of constraint conditions, the plurality of constraint conditions into a plurality of groups; and the debugging apparatus determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

### Supplementary Note 6a

The debugging method described in supplementary note 6, further including generating a relaxation problem which has, in a form of a continuous variable, a variable to be optimized in the optimization problem, in which in a case where there is no solution to the relaxation problem under the plurality of constraint conditions, the plurality of constraint conditions are divided into a plurality of groups.

### Supplementary Note 7

A program for causing a computer to function as a debugging apparatus, the program causing the computer to function as: a dividing means for, in a case where there is no solution to an optimization problem under a plurality of constraint conditions, dividing the plurality of constraint conditions into a plurality of groups; and a determining means for determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

### Supplementary Note 7a

The program described in supplementary note 7, further causing the computer to function as a generating means for generating a relaxation problem which has, in a form of a continuous variable, a variable to be optimized in the optimization problem, in which in a case where there is no solution to the relaxation problem under the plurality of constraint conditions, the dividing means is configured to divide the plurality of constraint conditions into a plurality of groups.

### Supplementary Note 8

A debugging apparatus, including at least one processor, the at least one processor carrying out: a dividing process of, in a case where there is no solution to an optimization problem under a plurality of constraint conditions, dividing the plurality of constraint conditions into a plurality of groups; and a determining process of determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

This debugging apparatus may further include a memory, and this memory may have stored therein a program for causing the at least one processor to carry out the dividing process and the determining process. Further, a computer-readable non-transitory tangible recording medium may have this program recorded thereon.

### REFERENCE SIGNS LIST

1, 1A, 1B: Debugging apparatus
11, 14: Dividing section
12, 15: Determining section
13: Generating section

What is claimed is:

1. A debugging apparatus, comprising
at least one processor, the at least one processor carrying out: a dividing process of, in a case where there is no solution to an optimization problem under a plurality of constraint conditions, dividing the plurality of constraint conditions into a plurality of groups; and
a determining process of determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

2. The debugging apparatus according to claim 1, wherein
the at least one processor further carries out a generating process of generating a relaxation problem which has, in a form of a continuous variable, a variable to be optimized in the optimization problem, and
in a case where there is no solution to the relaxation problem under the plurality of constraint conditions, in the dividing process, the at least one processor divides the plurality of constraint conditions into a plurality of groups.

3. The debugging apparatus according to claim 1, wherein
in the dividing process, the at least one processor divides the plurality of constraint conditions into a plurality of groups such that constraint conditions of the same type belong to the same group.

4. The debugging apparatus according to claim 3, wherein
in the dividing process, the at least one processor regards, as the constraint conditions of the same type, two constraint conditions which have the same number of variables and which are transformable from one of the two constraint conditions into another by interchange of variables.

5. The debugging apparatus according to claim 1, wherein
in the dividing process, the at least one processor divides a plurality of constraint conditions included in a group determined in the determining process into a plurality of subgroups, and
in the determining process, the at least one processor determines a subgroup exclusion of which causes the optimization problem to have a solution, by repeatedly carrying out a process of selecting one subgroup from the plurality of subgroups to judge whether there is a solution to the optimization problem under a constraint condition included in a subgroup other than the one subgroup selected.

6. A debugging method, comprising:
a debugging apparatus dividing, in a case where there is no solution to an optimization problem under a plurality of constraint conditions, the plurality of constraint conditions into a plurality of groups; and
the debugging apparatus determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.

7. A non-transitory recording medium storing a program for causing a computer to function as a debugging apparatus,
the program causing the computer to carry out:
a dividing process of, in a case where there is no solution to an optimization problem under a plurality of constraint conditions, dividing the plurality of constraint conditions into a plurality of groups; and
a determining process of determining a group exclusion of which causes the optimization problem to have a solution, by repeatedly carrying out a process of selecting at least one group from the plurality of groups to judge whether there is a solution to the optimization problem under a constraint condition included in a group other than the at least one group selected.
